(19) United States
(12) Patent Application Publication
(10) Pub. No.: US 2020/0068820 A1
(43) Pub. Date: Mar. 5, 2020

(54) IRRIGATION SYSTEM

(71) Applicants: Ezra Kohavi, Encino, CA (US); George Bar, Lancaster, CA (US)

(72) Inventors: Ezra Kohavi, Encino, CA (US); George Bar, Lancaster, CA (US)

(21) Appl. No.: 16/514,058

(22) Filed: Jul. 17, 2019

Related U.S. Application Data
(60) Provisional application No. 62/724,670, filed on Aug. 30, 2018.

(51) Int. Cl. A01G 25/02; B05B 3/00; F16L 33/22; F16L 41/08

(52) U.S. Cl. CPC A01G 25/026; B05B 3/00; B65H 2701/33; F16L 41/08; F16L 33/22

(57) ABSTRACT

Provided is an irrigation system including a flexible conduit having a first end connectable to a liquid supply, a second end opposite the first end, and a plurality of openings along a length thereof between the first and second ends, a plurality of rigid connectors coupled to the flexible conduit at respective ones of the plurality of openings, each of the plurality of rigid connectors including a first portion disposed in the flexible conduit and a second portion extending out of the flexible conduit through the respective one of the plurality of openings, and a plurality of attachment portions configured to be attached to the second portions of the plurality of rigid connectors.

### RELATED APPLICATIONS

This application claims the benefit of U.S. Provisional Application No. 62/724,670 filed Aug. 30, 2018, which is hereby incorporated herein by reference.

### FIELD OF INVENTION

The present invention relates generally to an irrigation system, and more to particularly to an above ground irrigation system.

### BACKGROUND

Home landscapes, which can contain trees, shrubs, flower beds, lawns, and small fields for example, use various methods to water the vegetation. A home garden, for example, may have a permanent underground sprinkler system to water the lawn, portable sprinklers for a field, a drip system for shrubs and flower or vegetable beds, and a regular garden hose in addition to the other system. While both the sprinkler system and the drip system are permanent and unmovable, the garden hose serves to function as a flexible solution for watering areas that do not have sprinklers or drip systems or areas that those existing systems cannot reach, to serve as a solution for watering new vegetation that was not included in the original plans, to access spots that are out of reach, or supply more water to specific locations.

### SUMMARY OF INVENTION

The present application provides irrigation systems for different landscapes, where a flexible, portable, above ground system that supports multiple irrigation methods is utilized.

According to one aspect, an irrigation system is provided that includes a flexible conduit having a first end connectable to a liquid supply, a second end opposite the first end, and a plurality of openings along a length thereof between the first and second ends, a plurality of rigid connectors coupled to the flexible conduit at respective ones of the plurality of openings, each of the plurality of rigid connectors including a first portion disposed in the flexible conduit and a second portion extending out of the flexible conduit through the respective one of the plurality of openings, and a plurality of attachment portions configured to be attached to the second portions of the plurality of rigid connectors.

According to another aspect, an irrigation system is provided that includes a flexible conduit having a first end connectable to a liquid supply, a second end opposite the first end, a first plurality of openings along a length thereof between the first and second ends, and a second plurality of openings along a length thereof between the first and second ends opposite a respective one of the first plurality of openings, a plurality of rigid connectors coupled to the flexible conduit at respective ones of the first and second plurality of openings, each of the plurality of rigid connectors including a first portion disposed in the flexible conduit, a second portion extending out of the flexible conduit through the respective one of the first plurality of openings, and a third portion extending out of the flexible conduit through the respective one of the second plurality of openings, and a plurality of attachment portions configured to be attached to the second portions of the plurality of rigid connectors.

According to still another aspect, an irrigation system is provided that includes a flexible conduit having a first end connectable to a liquid supply, a second end opposite the first end, and a plurality of openings along a length thereof between the first and second ends, a plurality of rigid connectors coupled to the flexible conduit at respective ones of the plurality of openings, and a plurality of attachment portions configured to be attached to the plurality of rigid connectors to control a flow of liquid from the liquid supply through the rigid connectors.

The foregoing and other features of the application are described below with reference to the drawings.

### BRIEF DESCRIPTION OF THE DRAWINGS

FIG. 1 illustrates an exemplary irrigation system.

FIG. 2 is a schematic of the flexible hose performing the basic function (Function 1) as a traditional garden hose.

FIG. 3 is a schematic of the system, functioning as a sprinkler's system (function 2).

FIG. 4 Is a schematic of the system, functioning as a drip irrigation system (function 3).

FIG. 5 Is an exemplary view showing an expandable system, which can cover larger areas with a network of multiple, same flexible hoses with rigid connectors that can cover a vast landscape in different layouts.

FIG. 6 is a sectional view of the opening in the hose, which is a rigid connector that contains a threaded “Tee” shaped part, made of hard, rigid material (such as PVC or metal) inserted into the flexible hose.

FIG. 6A is a view of a low profile T shaped connector, made of rigid material (such as PVC, metal, or others) embedded into the flexible hose.

FIG. 7 is a detailed sectional view of the “Tee” shaped connector, designed to fit hoses where the diameter of the hose is smaller than the diameter of the threaded vertical outlet sticking out of the connector. The vertical outlets fit any standard riser for a sprinkler head and drip hoses' connectors.

FIG. 7A is a 3d view of the item in FIG. 7.

FIG. 8 is a detailed sectional view of the optional two-way rigid connector that, like the T connector is designed to fit horizontally to the exact inside diameter of the hose. The vertical outlets fit any standard riser for a sprinkler head and drip hoses' connectors, but also a specially designed sprinkler's anchor stand (as shown in FIG. 13).

FIG. 9 is a side view of the specially designed part to serve as sprinkler anchor, with a male thread that fit the two-way connector

FIG. 10 is a side view of the T connector, designed with 2 “ears” to be used with 2 anchors that secure the sprinkler in its vertical position and prevents it from wobbling during operation

FIG. 11 is a view of one of the ways that the special hose can be used with a mix of sprinklers and drips

FIG. 12 is a view of 4-way connector and a 3-way connector and the extension hoses that are connected to them

FIG. 13 is a view of 4-way rigid part with sprinkler head connected from one side and the special anchor part connected from the other side of the rigid part

FIG. 14 is a view of the hose with the cut hole and the 2 side cuts before the insertion of the T connector

FIG. 15 is a view of the few possibilities of closing the protruding opening of the T connector: One is a closed cup and the other is a one way valve.

### DETAILED DESCRIPTION

The present application provides an alternative solution to existing irrigation systems by offering one flexible, portable, easy to use, and less expensive irrigation system that can easily be adjusted to replace or add to any of the existing solutions and can be used in different layouts according to the user's needs. The system is portable, allowing the user to pack the system after use, leaving the irrigated area clean of any devices sticking out of the ground and preventing damage to the system due to other tasks being performed in the area, such as mowing, cleaning, planting, etc. The user can easily move the system to different locations, thereby eliminating the need to install a permanent system in each location (front and back yard, small adjacent field or orchard, another property, etc.), and eliminating the need in larger areas to use cumbersome, rigid, heavy fixtures such as metal or plastic pipes.

The present application includes a flexible hose or hoses, or any flexible conduits that connect to a liquid source and have multiple rigid connectors embedded inside the hose at predetermined distances from each other. The rigid connectors can be T-style, two-way style, or with any suitable number of outlets. The parts may be hollow; where a horizontal part is designed to fit the internal dimension of the hose, and can be embedded during the hose manufacture process and secured to the internal layer of the hose by a suitable adhesive or heat or other bonding means.

The end of the hose or any of the rigid embedded connectors can be capped, or can be connected to a one way valve, depends on the desired system. The hose can be any flexible conduit that enables the transport of fluids, such as garden rubber hose, PVC flex hose, etc. The water source can be a faucet, multiple faucets with any adapter that connects the faucets to one hose, or any other source of fluids. The embedded rigid connectors can be made of metal, PVC or other rigid material, and the multiple rigid connectors can fit different purposes and be shaped accordingly as T-connector, two-ways connector, etc.

The exemplary system connects, by plugging directly to the rigid embedded connectors, to different irrigation apparatus such us sprinklers, drips, extension hoses, similar hoses, mounting spikes, etc., which all allow the maximum flexibility of use. An additional hardware can be used to regulate pressure when needed, in cases, for example, of mixing sprinklers and drip to system on the same hose.

The one hose solution enables a high pressure to be maintained (by eliminating such solutions as several hoses connected to each other by thread, with connectors in between, to create one long hose, causing leaks and loss of pressure) thereby enabling the operation of many sprinklers at the same time. The embedded rigid connectors allow the user to choose almost any suitable sprinkler in the market, according to their preferences and needs. Thus, for example, if pressure is not sufficient in the water source, specially designed low pressure sprinklers can be mounted. Another way of using this solution is by connecting numerous hoses to several water sources and interconnecting the hoses to create coverage for large area, as pressure permits.

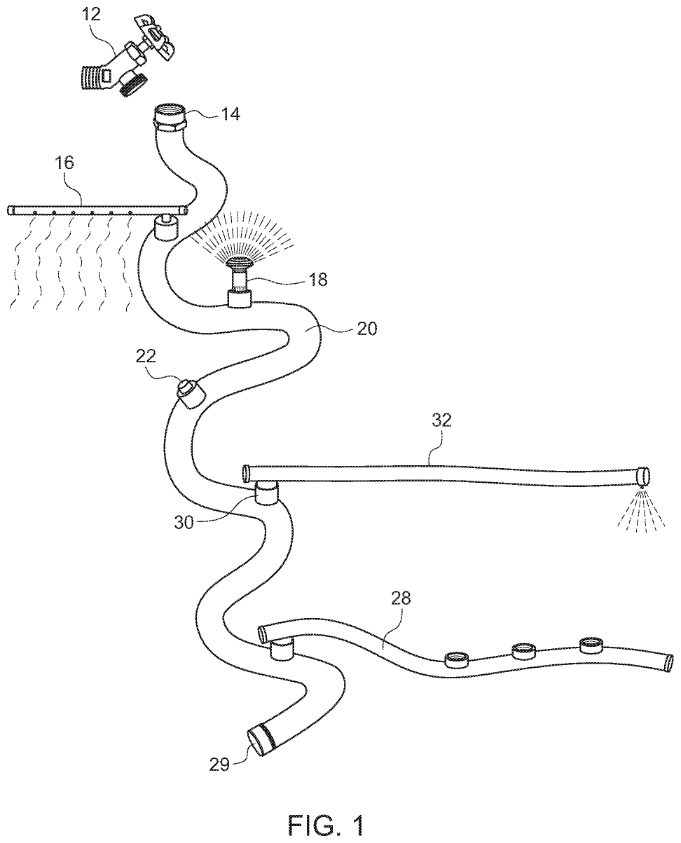

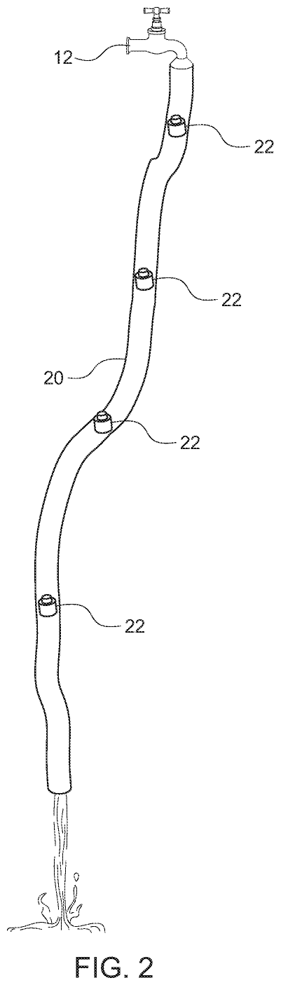

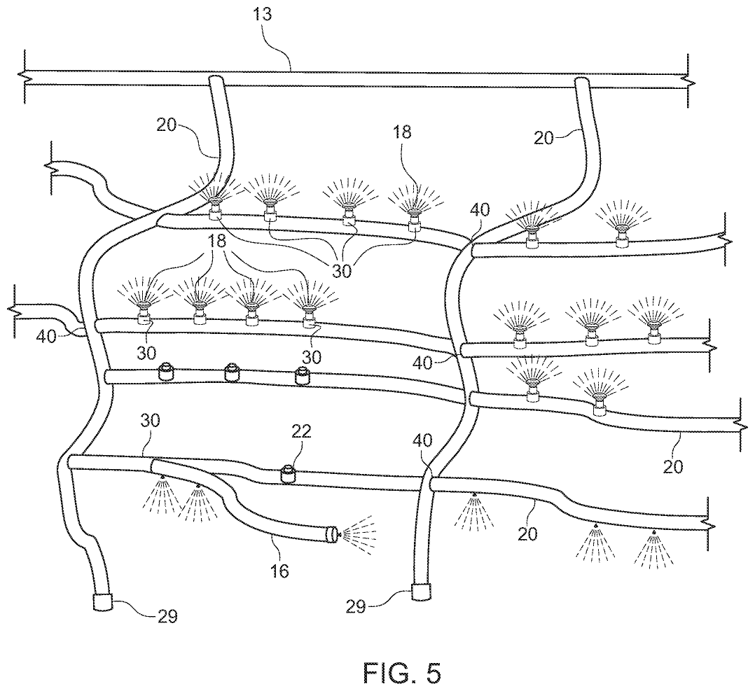

Turning now to FIG. 1, a hose 20 is shown that can be connected to liquid source 12, such as a faucet via connector 14. The hose 20 includes multiple rigid connectors 30 along the hose that are either capped as shown in FIG. 2, or serve as connectors 30 for different elements, such as drip system 16, sprinkler heads 18, single drip conduit 32, or to other similar hoses to create a network for irrigation of larger areas 28, as shown in FIG. 5. Each such connector can be sealed, when not in use, by a male threaded cap 22 (FIG. 2), enabling it to serve as a regular garden hose. When the rigid connectors 30 are linked to sprinkler heads, the end of the hose is capped 29, and the hose becomes a complete sprinkler system, and when the connection is made to drip pipes, it is a complete drip system.

In FIG. 2 the hose 20 is connected to the liquid source 12 and all the connectors along the hose are sealed with the male threaded caps 22, thus enabling water to flow all the way through, thereby serving the purpose of a traditional water hose.

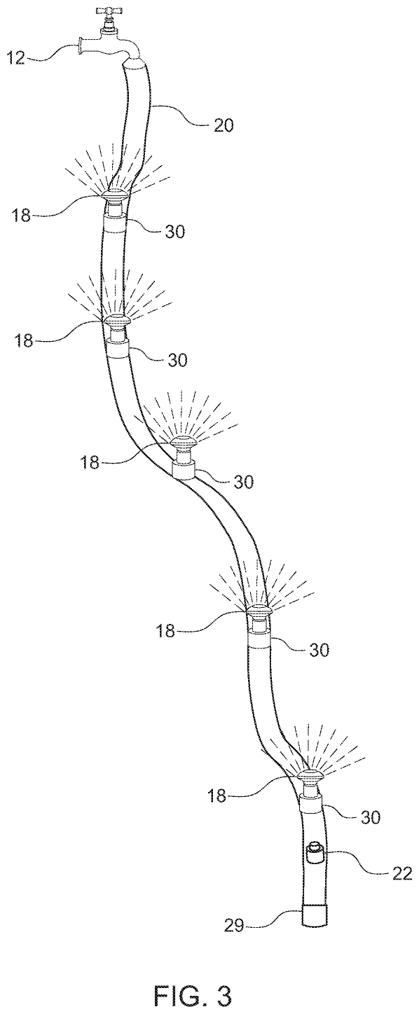

The hose 20 can also be configured as a complete sprinkler system, as illustrated in FIG. 3 by sealing the end of the hose with a female cap 29, and removing the caps from the rigid connectors 30 along the hose 20, in order to attach the sprinklers 18 to the connectors.

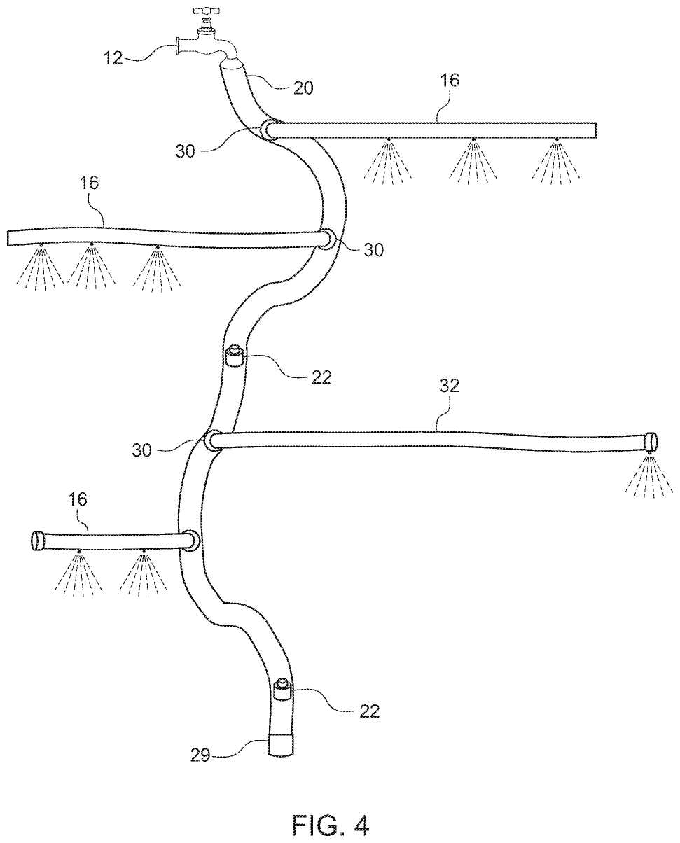

The hose 20 can also serve as a complete drip irrigation system as shown in FIG. 4. The end is sealed with a cap 29, and drip pipes 16 are attached to the uncapped connectors 30. Any of the connectors along the hose that are not in to use can be capped 22 or can include a one-way valve to stop flow in the absence of a connecting element. The drip pipes 16 can each include a plurality of openings along their length for supplying liquid to areas along the length of the drip pipe 16, or have only one opening with a single drip conduit 32.

Turning now to FIG. 5, in addition to using a single hose for the flexible, above ground irrigation, a network of flexible hoses, with the rigid two-way connectors 40, enables the coverage of larger areas, such as fields and orchards. Multiple hoses can be connected to the water supply, such as water pipe 13, and are interconnected to each other, with similar flexible hoses. Utilizing the flexible hoses, the system can be laid out in different shapes, allowing the coverage and irrigation of areas that are curved and have different heights, such as slopes, and uneven grounds, and where the vegetation is not planted in straight lines.

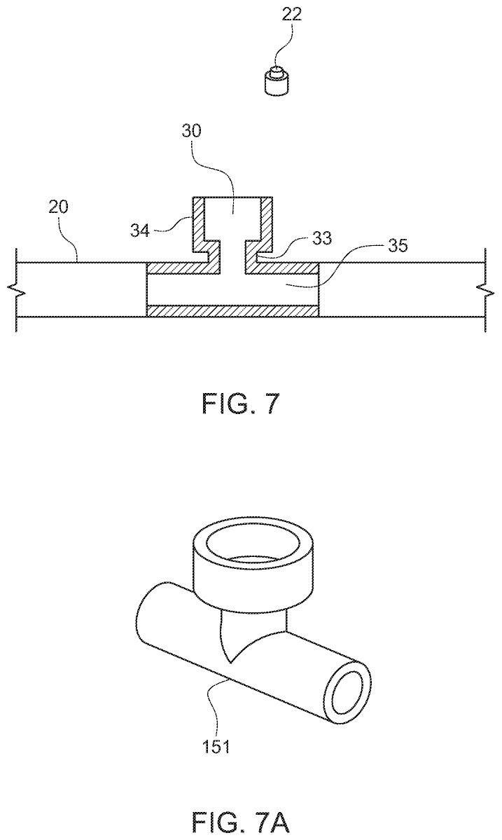

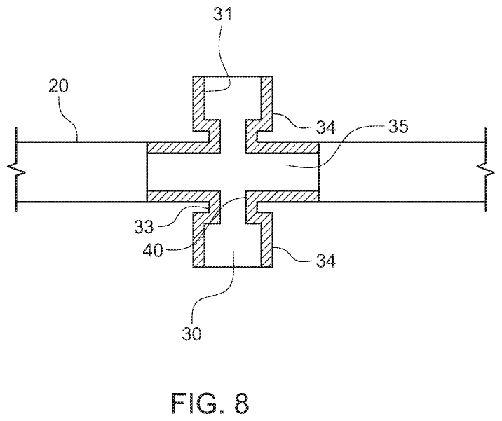

FIG. 7 shows a close up of the rigid connector 30 in the hose 20. The connector 30 can be substantially T-shaped, with a horizontal portion 35, which fits inside the hose itself, and a vertical portion 34 having a female thread 31 (FIG. 8), such as a half inch thread, that fits any standard risers that are connecting the sprinkler heads and drip pipes, as well as fitting the caps 22, with a male thread, such as a half inch thread, which is used to close some or all openings.

The T-shape rigid connector has its horizontal portion 35 with its outside diameter matching the hose 20 inside diameter, the same diameter as the vertical neck 33 that connects the horizontal portion to the upper threaded part 34. The T-shaped connector is secured inside the hose, by different methods, like a permanent adhesive, to ensure no water leaks in a high water pressure, and is air tight to maintain a pressure that allows the operation of many sprinklers on the same line. Also, the T-shaped rigid connector 30 (FIG. 7) is designed to fit hoses where the diameter of the hose is smaller than the diameter of the part that protruding the hose and connecting to other devices 34. Turning now to FIG. 7A, the horizontal hollow portion 151, and similarly the horizontal portions shown in other figures, of the embedded rigid connector that is bonded inside of the hose but is not be too long in order not to lose the flexibility of the hose, yet be rigid enough to hold the sprinkler heads while they are in full operation.

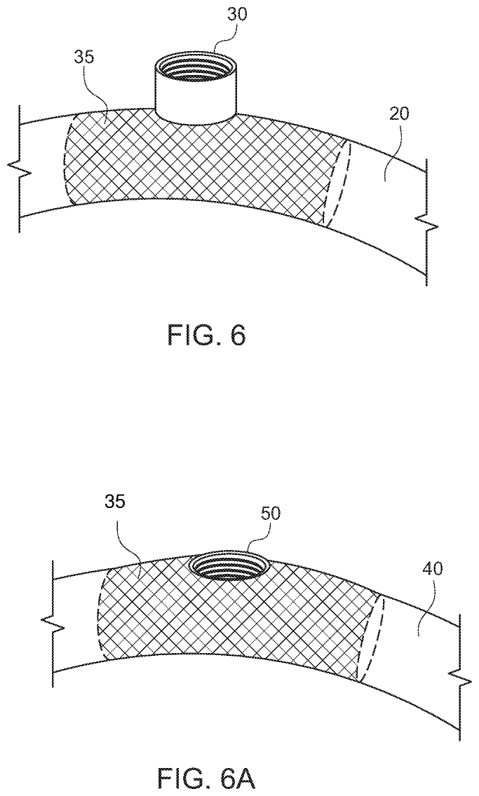

The embedded rigid part can include a low profile embedded connector with protruding outlet as shown in FIG. 6A, almost flush with the hose, which can be used for hoses with the internal diameter that is larger than the diameter of the protruding outlet 34. The protruding part can be made with minimum elevation, but sufficient threads to enable holding a sprinkler head, so when the riser for the sprinkler head is plugged in; it would not block the water flow inside the hose.

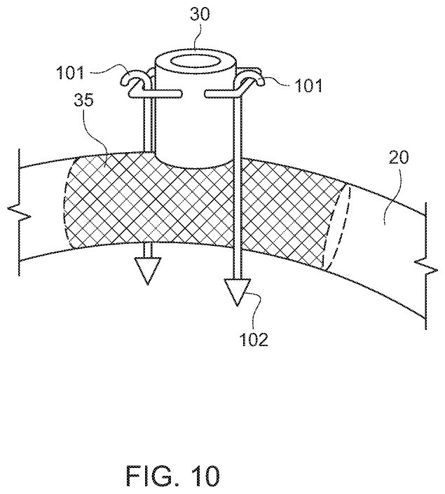

In another aspect, the embedded connector with an outlet to the outside of the hose, where the diameter of the outlet is larger than the diameter of the hose (FIG. 7 and FIG. 7A), for example for one half inch rigid opening to fit one half inch sprinkler heads, when using a hose with external diameter of, for example five eighths of an inch, the internal diameter of this hose will be less than one half of an inch. The outlet of the embedded connector will be shaped like a mushroom. In addition, this part can have mounting ears on its side that can be used to secure to the ground the embedded rigid part from wobbling side to side during a normal sprinkler operation, for example as shown in FIG. 10.

Also the outlets of the embedded connector can be threaded to connect sprinkler heads, drip pipes, hoses or other devices, but be also connected with twist-and lock-mechanism, push-on fitting or any other way.

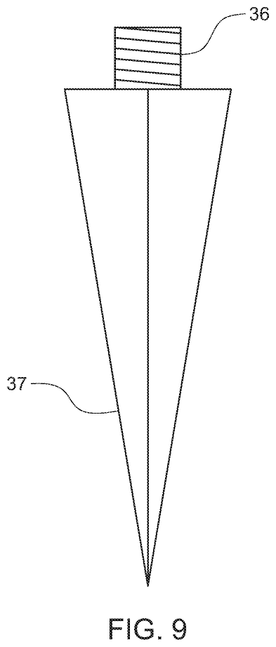

The two-way connector 40 shown in detail in FIG. 8 includes a second vertical opening that is similar to the other side, and each vertical part can also serve to connect to either a sprinkler spike or stand 37, or to hoses in both sides, to create the irrigation network shown in FIG. 5. The two-way connector is usually a part for larger diameter hoses that cover larger areas, such as big gardens or fields. The sprinkler stand body is a sharp spike, anchor 37 and at its head is a male thread 36 that fit the rigid connector female thread 31, as shown in FIG. 8 and FIG. 9.

In order to keep the sprinkler head in place and in a vertical position the special designed rigid connector 30 in FIG. 10 has two ears, or built-in rings 101 to which J-shaped anchor stands 102 are inserted. The anchor stands are inserted into the ground on both sides of the sprinkler, thus keeping it stable.

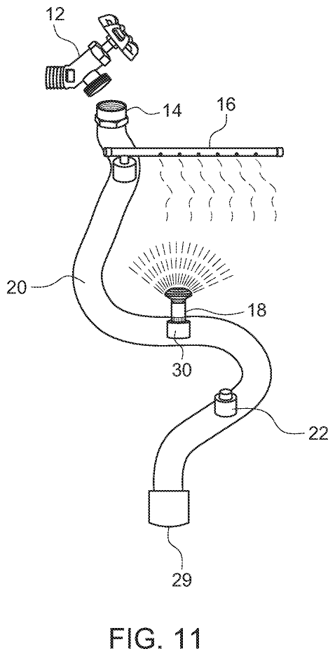

One of the uses of the special hose is as a mix of sprinkler and drip systems, where some of the T-shaped rigid connector outlets are capped 22, the end of the hose is capped 29, some of the T-shaped connector outlets 30 are connected to a drip system 16 and some to sprinkler heads 18, as shown in FIG. 11.

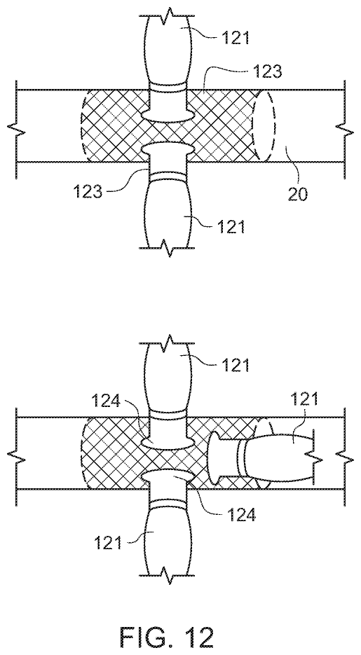

One of the possibilities for the rigid connector embedded inside the hose is to have multiple outlets to connect to multiple extension hoses. The rigid connector that is embedded in the hose is designed with two outlets 123 and with two extension hoses 121 and is connected to them. Similarly, the rigid embedded connector has three openings 124 and with three hoses 121 connected to them, as shown in FIG. 12.

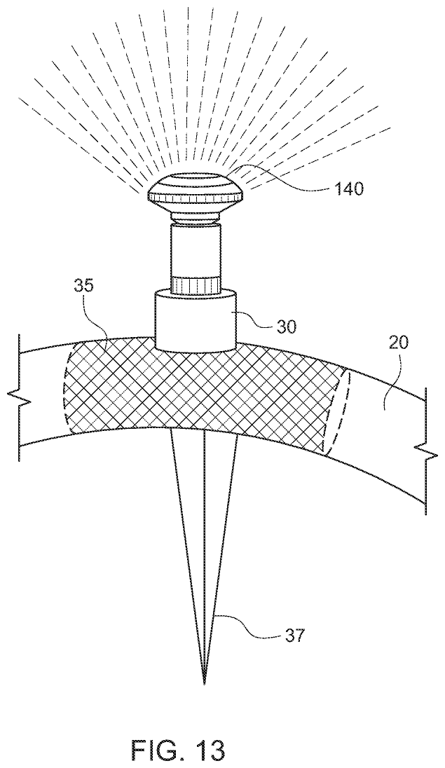

When using the two-way connector, the way to anchor the sprinklers and keep them vertical, as shown in FIG. 13, is to use the specially designed anchor stand 37, that can be screwed into the lower part of the connector 30 and inserted in the ground.

One method of manufacturing the hose includes cutting a circular hole in the spot where the T-shaped part is to be inserted. The hole diameter is the same as the inside diameter of the hose, with two small cuts on both sides of the hole alongside the hose. The horizontal parts of T connector are then coated with adhesive and forced through the cut hole from both sides of the hole and pressed until bonding is completed.

Another method of manufacturing is using an automatic robotic heat apparatus that can reach high temperature that will melt the rubber layer of the hose where the T part is inserted.

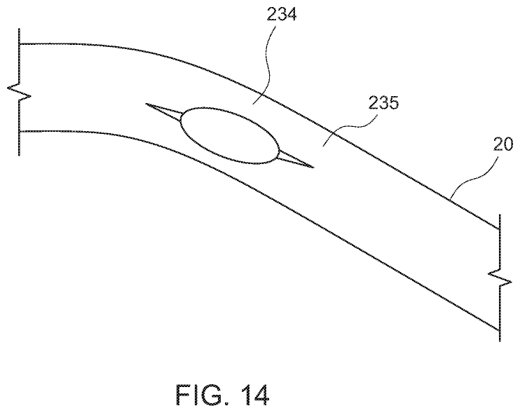

As shown in FIG. 14 as an example of the preparation the hose for insertion of one T connector. Viewed are the cut hole 234 and the two side cuts 235 in the hose before insertion of the T connector.

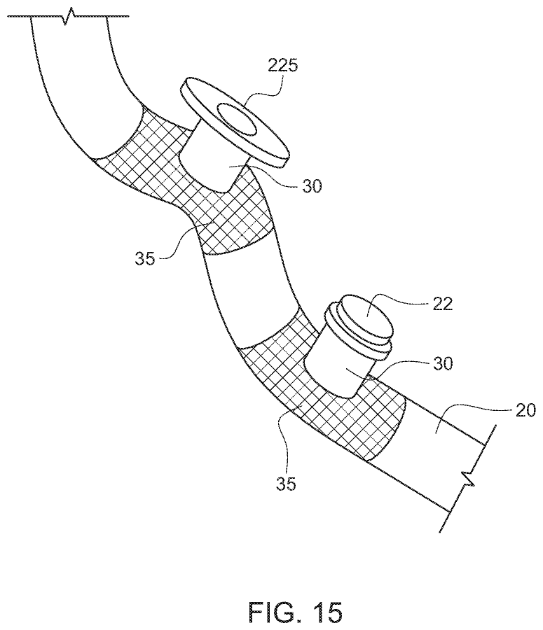

FIG. 15 is an example of the different possibilities of closing the protruding part 30 of the T connector 35 embedded in the hose 20 with a cap, when it's being used as a regular hose, 22 or with a one way valve 225 when connection is required.

Although certain embodiments have been shown and described, it is understood that equivalents and modifications falling within the scope of the appended claims will occur to others who are skilled in the art upon the reading to and understanding of this specification.

What is claimed is:

1. An irrigation system including:
a flexible conduit having a first end connectable to a liquid supply, a second end opposite the first end, and a plurality of openings along a length thereof between the first and second ends;
a plurality of rigid connectors coupled to the flexible conduit at respective ones of the plurality of openings, each of the plurality of rigid connectors including a first portion disposed in the flexible conduit and a second portion extending out of the flexible conduit through the respective one of the plurality of openings; and
a plurality of attachment portions configured to be attached to the second portions of the plurality of rigid connectors.

2. The irrigation system according to claim 1, wherein the plurality of rigid connectors are non-removably connected in the flexible conduit.

3. The irrigation system according to claim 1, wherein the first and second parts of each of the rigid connectors are tubular.

4. The irrigation system according to claim 1, wherein the first part of each flexible connector is a horizontal tubular portion disposed in the flexible conduit, and the second part of each flexible connector is vertical tubular portion extending out of the flexible conduit substantially perpendicular to the respective first portion.

5. The irrigation system according to claim 1, wherein the plurality of attachment portions includes at least one of a sprinkler head attachment, a drip pipe attachment, or a cap for sealing one of the second portions.

6. The irrigation system according to claim 1, wherein the second end is connectable to another flexible conduit or to a cap to close the second end.

7. The irrigation system according to claim 1, further including a cap connected to the second end to prevent flow therethrough.

8. The irrigation system according to claim 1, wherein the flexible conduit includes another plurality of openings along the length thereof between the first and second ends, each of the another plurality of openings being opposite a respective one of the plurality of openings.

9. The irrigation system according to claim 8, wherein each rigid connector includes a third portion extending out of the flexible conduit through the respective one of the another plurality of openings.

10. The irrigation system according to claim 9, further including at least one anchor connectable to one of the third portions and configured to be inserted into a surface to anchor the flexible conduit.

11. The irrigation system according to claim 1, wherein at least one of the rigid connectors includes a pair of ears extending from opposite sides of the at least one rigid connector.

12. The irrigation system according to claim 11, further including a pair of anchors each connectable to one of the pair of ears and configured to be inserted into a surface to anchor the flexible conduit.

13. The irrigation system according to claim 1, wherein the plurality of attachment portions includes at least one sprinkler head attachment configured to be coupled to one of the second portions, at least one drip pipe attachment configured to be coupled to one of the second portions, and at least one cap configured to be coupled to one of the second portions for sealing the second portion.

14. An irrigation system including:
a flexible conduit having a first end connectable to a liquid supply, a second end opposite the first end, a first plurality of openings along a length thereof between the first and second ends, and a second plurality of openings along a length thereof between the first and second ends opposite a respective one of the first plurality of openings;
a plurality of rigid connectors coupled to the flexible conduit at respective ones of the first and second plurality of openings, each of the plurality of rigid connectors including a first portion disposed in the flexible conduit, a second portion extending out of the flexible conduit through the respective one of the first plurality of openings, and a third portion extending out of the flexible conduit through the respective one of the second plurality of openings; and
a plurality of attachment portions configured to be attached to the second portions of the plurality of rigid connectors.

15. The irrigation system according to claim 14, wherein the first part of each flexible connector is a horizontal tubular portion disposed in the flexible conduit, the second part of each flexible connector is vertical tubular portion extending out of the flexible conduit substantially perpendicular to the respective first portion in a first direction, and the third part of each flexible connector is a vertical tubular portion extending out of the flexible conduit substantially perpendicular to the respective first portion in a second direction opposite the first direction.

16. The irrigation system according to claim 14, further including at least one anchor connectable to one of the third portions and configured to be inserted into a surface to anchor the flexible conduit.

17. The irrigation system according to claim 14, wherein each second portion has a first inner diameter and each third portion has a second inner diameter greater than the first diameter.

18. An irrigation system including:
a flexible conduit having a first end connectable to a liquid supply, a second end opposite the first end, and a plurality of openings along a length thereof between the first and second ends;
a plurality of rigid connectors coupled to the flexible conduit at respective ones of the plurality of openings; and
a plurality of attachment portions configured to be attached to the plurality of rigid connectors to control a flow of liquid from the liquid supply through the rigid connectors.

19. The irrigation system according to claim 18, wherein the plurality of openings includes a first and second plurality of openings along the length, and wherein each of the plurality of rigid connectors including a first portion disposed in the flexible conduit, a second portion extending out of the flexible conduit through a respective one of the first plurality of openings, and a third portion extending out of the flexible conduit through a respective one of the second plurality of openings.

20. The irrigation system according to claim 18, wherein the plurality of openings includes a first, second, and third plurality of openings along the length, and wherein each of the plurality of rigid connectors including a first portion disposed in the flexible conduit, a second portion extending out of the flexible conduit through a respective one of the first plurality of openings, a third portion extending out of the flexible conduit through a respective one of the second plurality of openings, and a fourth portion extending out of the flexible conduit through a respective one of the third plurality of openings.
